(19) United States
(12) Patent Application Publication
(10) Pub. No.: US 2026/0167194 A1
(43) Pub. Date: Jun. 18, 2026

(54) VEHICLE CONTROL METHOD, VEHICLE CONTROL APPARATUS, AND VEHICLE SYSTEM HAVING THE SAME

(71) Applicants: HYUNDAI MOTOR COMPANY, SEOUL (KR); KIA CORPORATION, SEOUL (KR)

(72) Inventors: Hyung Joon Kim, Hwaseong-si (KR); Jae Young Kim, Hwaseong-si (KR); Jung Gyu Kim, Hwaseong-si (KR)

(73) Assignees: HYUNDAI MOTOR COMPANY, SEOUL (KR); KIA CORPORATION, SEOUL (KR)

(21) Appl. No.: 19/213,792

(22) Filed: May 20, 2025

(30) Foreign Application Priority Data
Dec. 12, 2024 (KR) 10-2024-0185028

(51) Int. Cl. B60W 30/18; B60T 8/1755; B60T 8/1761; B60T 8/52; B60T 13/74; B60W 10/188

(52) U.S. Cl. CPC B60W 30/18127; B60T 8/1755; B60T 8/1761; B60T 8/52; B60T 13/745; B60W 10/188; B60T 2270/60; B60W 2520/26; B60W 2540/18

(57) ABSTRACT

A vehicle control method includes: receiving a braking request signal from a driver; collecting vehicle braking execution information performed based on the braking request signal; deriving additional allowance information of rear wheel regenerative braking based on the braking request signal and the braking execution information; and controlling the vehicle based on the additional allowance information of the rear wheel regenerative braking. The braking execution information of the vehicle includes regenerative braking execution information and hydraulic braking execution information.

### CROSS-REFERENCE TO RELATED APPLICATION(S)

This application claims the benefit of and priority to Korean Patent Application No. 10-2024-0185028 filed in the Korean Intellectual Property Office on Dec. 12, 2024, the disclosure of which is incorporated herein by reference in its entirety.

### BACKGROUND

### 1. Technical Field

The present disclosure relates to a vehicle control method, a vehicle control apparatus, and a vehicle system having the same.

### 2. Description of Related Art

Eco-friendly vehicles such as hybrid vehicles, electric vehicles, and fuel cell vehicles are equipped with a motor drive system for driving and power generation. When braking these eco-friendly vehicles, regenerative braking is performed by operating a motor as a generator in addition to the existing hydraulic friction brake, and converting kinetic energy of the vehicle into electric energy while braking.

Generally, when braking is performed by allowing a driver to operate a brake pedal, a total braking amount determined by an amount of the brake pedal being operated is distributed between hydraulic braking and regenerative braking.

In order to increase the energy efficiency of the vehicle, it may be advantageous to set a regenerative braking torque to a large value, but a maximum torque of the regenerative braking is limited so that driving stability of the vehicle may be guaranteed even on low-friction surfaces such as snowy roads, icy roads, and rainy roads.

However, when the regenerative braking torque is excessively limited, there may be a problem that the electric efficiency of the vehicle may be reduced even on general or high-friction surfaces on which stability of the vehicle is not problematic.

### SUMMARY

An aspect of the present disclosure is to provide a vehicle control method, a vehicle control apparatus, and a vehicle system having the same, which may improve fuel efficiency by additionally allowing rear wheel regenerative braking of a vehicle.

An aspect of the present disclosure is to provide a vehicle control method, a vehicle control apparatus, and a vehicle system having the same, which may maximize a driving distance and electric efficiency without compromising the stability of the vehicle on a high-friction road surface.

In order to achieve the above-described aspects, a vehicle control method, a vehicle control apparatus, and a vehicle system having the same, as described hereinafter is provided.

An embodiment of the present disclosure provides a vehicle control method. The method being performed on a computing device including a processor, and a storage medium storing instructions executable by the processor. The method including: receiving a braking request signal from a driver; collecting vehicle braking execution information performed based on the braking request signal; and deriving additional allowance information of rear wheel regenerative braking based on the braking request signal and the vehicle braking execution information. Additionally, the method includes controlling the vehicle based on the additional allowance information of the rear wheel regenerative braking. The vehicle braking execution information includes regenerative braking execution information and hydraulic braking execution information.

An embodiment of the present disclosure provides a vehicle control apparatus including: a processor; and a storage medium storing instructions executable by the processor that, when executed by the processor, cause the processor to: receive a braking request signal from a driver; collect braking execution information of a vehicle, performed based on the braking request signal; derive additional allowance information of rear wheel regenerative braking based on the braking request signal and the braking execution information of the vehicle. Additionally, the instructions cause the processor to control the vehicle based on the additional allowance information of the rear wheel regenerative braking. The braking execution information of the vehicle includes regenerative braking execution information and hydraulic braking execution information.

An embodiment of the present disclosure provides a vehicle system including: a battery; a driving mechanism including a front wheel and a rear wheel; and a processor. The processor is configured to: receive a braking request signal of a driver; collect braking execution information of a vehicle performed based on the braking request signal; derive additional allowance information of the rear wheel regenerative braking based on the braking request signal and the braking execution information of the vehicle, and control the vehicle based on the additional allowance information of the rear wheel regenerative braking. The braking execution information of the vehicle includes regenerative braking execution information and hydraulic braking execution information.

The present disclosure may provide a vehicle control method, a vehicle control apparatus, and a vehicle system having the same, which may improve fuel efficiency by additionally allowing rear wheel regenerative braking of a vehicle.

The present disclosure may provide a vehicle control method, a vehicle control apparatus, and a vehicle system having the same, which may maximize a driving distance and electric efficiency without compromising the stability of the vehicle on a high-friction road surface.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a block diagram of a vehicle system according to an embodiment of the present disclosure;

FIG. 2 is a flowchart of a vehicle control method according to an embodiment of the present disclosure;

FIG. 3 is another flowchart of a vehicle control method according to an embodiment of the present disclosure;

FIG. 4 is a graph illustrating braking torque when a method for controlling a vehicle according to an embodiment of the present disclosure is performed; and

FIG. 5 is a block diagram of a computing device capable of entirely or partially implementing a vehicle control device according to an embodiment of the present disclosure.

### DETAILED DESCRIPTION

Hereinafter, embodiments of the present disclosure are described with reference to the drawings. The following detailed description is provided to help gain a comprehensive understanding of the methods, apparatuses, and/or systems described herein. However, these are only examples, and the present disclosure is not limited thereto.

In describing example embodiments of the present disclosure in detail, when it is determined that a detailed description of known technologies associated with the present disclosure may unnecessarily obscure the gist of the present disclosure, the detailed description thereof has been omitted. Furthermore, the terms described below are defined in consideration of functions in the present disclosure, and may vary according to the intention or practice of a user or an operator. Therefore, the definition thereof should be based on the content throughout this specification. The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a portion or combinations thereof, and shall not be construed to preclude any presence or possibility of one or more other characteristics, numbers, steps, operations, elements, parts or combinations thereof.

Furthermore, throughout the specification, the terms “connected to” or “coupled to” are used to designate a connection or coupling of one element to another element and include both a case where an element is “directly connected or coupled to” another element and a case where an element is “indirectly connected or coupled to” another element via still another element.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

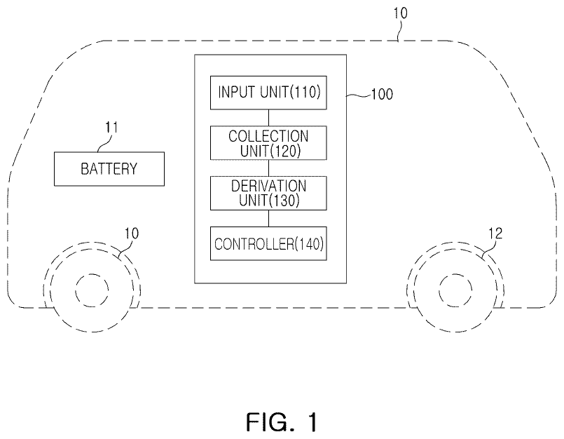

FIG. 1 is a block diagram of a vehicle system according to an embodiment of the present disclosure. Referring to FIG. 1, a vehicle system 10 may include a battery 11, a driving mechanism 12, and a vehicle control device 100.

The battery 11 may include a rechargeable or dischargeable secondary battery. The vehicle system 10 may be a hybrid vehicle or an electric vehicle configured to drive a motor using power supplied from the battery 11.

Additionally, the battery 11 may supply power to other components included in the vehicle system 10. For example, the battery 11 may supply power to and operate a display, an input module, a communication module, a sensor module, a memory, and a processor included in the vehicle system 10.

The vehicle system 10 may further include one or more sensors. The one or more sensors may be installed inside or outside the vehicle system 10 and may sense information related to a status or a driving situation of the vehicle system 10.

The one or more sensors may include, for example, at least one of a wheel speed sensor sensing the speed of the wheels of a vehicle, a vehicle speed sensor sensing the driving speed of the vehicle, an accelerator pedal position sensor (APS) linked to an operation of an accelerator pedal, a brake pedal sensor (BPS) linked to an operation of a brake pedal, a steering angle sensor (SAS) linked to an operation of a steering wheel, a temperature sensor sensing a temperature inside or outside the vehicle, an image sensor configured to acquire image data inside or outside the vehicle, and a distance sensor configured to measure a distance from the vehicle to an obstacle disposed in one direction.

The driving mechanism 12 may include front wheels and rear wheels. The driving mechanism 12 may drive the vehicle using driving power supplied from a motor.

The vehicle control device 100 may include an input unit 110, a collection unit 120, a derivation unit 130, and a controller 140.

The input unit 110 may receive a brake request signal of a driver. The braking request signal of the driver may be input through the brake pedal sensor.

When the braking request signal of the driver is input, the vehicle system 10 may control the driving mechanism 12 to brake the vehicle.

The collection unit 120 may collect braking execution information of a vehicle performed based on the braking request signal. The braking execution information of the vehicle may include regenerative braking execution information and hydraulic braking execution information.

The derivation unit 130 may determine an additional allowance condition (e.g., allowance condition) of rear wheel regenerative braking based on the braking request signal and the braking execution information.

The derivation unit 130 may derive additional allowance information (e.g., allowance information) of the rear wheel regenerative braking when the additional allowance condition is satisfied. The additional allowance condition of the rear wheel regenerative braking may include one or more conditions.

For example, the additional allowance condition of the rear wheel regenerative braking may include a first allowance condition for determining whether a braking request signal is input, and a second allowance condition for determining whether an execution amount of the rear wheel regenerative braking is equal to a basic allowance amount of the rear wheel regenerative braking. The additional allowance condition may include a third allowance condition for determining whether master cylinder pressure of the vehicle is greater than or less than minimum secured hydraulic pressure, and a fourth allowance condition for determining whether a stability control function of the vehicle is not operating.

The derivation unit 130 may derive additional allowance information of the rear wheel regenerative braking when all of the first to fourth allowance conditions are satisfied.

The derivation unit 130 may derive additional allowance information of the rear wheel regenerative braking based on the braking request signal and braking execution information. The additional allowable allowance of the rear wheel regenerative braking refers to the supplementary regenerative braking capacity that can be applied to rear wheels beyond their default regenerative braking level when specific operational or environmental conditions are met. Specific conditions may be satisfied, for example, when driving on a high friction road or on an uphill sloped road. The additional allowance information of the rear wheel regenerative braking may include an additional allowance amount of the rear wheel regenerative braking and an increase rate of the additional allowance amount.

The derivation unit 130 may derive the additional allowance amount as a smaller value among a value obtained by subtracting a torque based on the regenerative braking execution information and minimum secured hydraulic pressure from a total braking torque included in the braking request signal, and a preset maximum additional allowance amount.

An additional allowance amount (T_{ADD}) of the rear wheel regenerative braking may be expressed using mathematical expression 1. In mathematical expression 1, Tₜₒₜₐₗ may represent a total braking torque included in the braking request signal, T_{Frt} may represent a front wheel regenerative braking execution amount, T_{Rr} is a rear wheel regenerative braking execution amount, Hydₘᵢₙ is minimum secured hydraulic pressure, f_{Torque} is a torque factor (Nm/bar), and T_{ADDMax} may represent a preset maximum additional allowance amount.

$$[ Mathematical expression 1 ]$$

$${T}_{ADD} = min [ ( {T}_{total} - {T}_{Frt} - {T}_{Rr} = {Hyd}_{min} \times {f}_{Torque} ) , {T}_{ADDMax} ]$$

Minimum secured hydraulic pressure (Hydₘᵢₙ) may have a preset value based on hydraulic compensation speed. In the vehicle system 10, as compared to increasing the hydraulic pressure required for hydraulic braking from 0 to a required value, the time required for increasing from the minimum secured hydraulic pressure (Hydₘᵢₙ) to the required value is shorter.

Accordingly, the minimum secured hydraulic pressure may have a preset value in order to reduce the delay time for increasing the hydraulic pressure, i.e., to improve the hydraulic pressure compensation speed.

A preset maximum additional allowance amount (TADD_{Max}) may have a value obtained experimentally according to the vehicle system 10 or the structure and specifications of the vehicle.

The derivation unit 130 may derive an increase rate of the additional allowance amount as a smaller value among a ratio of the additional allowance amount of the rear wheel regenerative braking to reference increase time and a preset maximum increase rate. For instance, if the ratio of the additional allowance amount for rear wheel regenerative braking R1 is less than the preset maximum increase rate Rm, the derivation unit 130 may determine the increase rate of the additional allowance amount as R1. Conversely, if the ratio of the additional allowable amount R2 exceeds the preset maximum increase rate Rm, the derivation unit 130 may determine the increase rate of the additional allowance amount as Rm. The preset maximum increase rate may have a value obtained experimentally according to the structure and specifications of the vehicle system 10 or the vehicle.

The controller 140 may control the vehicle based on the additional allowance information of the rear wheel regenerative braking. The controller 140 may control the vehicle so that the allowance amount of the rear wheel regenerative braking increases based on the additional allowance amount of the rear wheel regenerative braking and an increase rate of the additional allowance amount of the rear wheel regenerative braking.

The derivation unit 130 may determine an additional release condition of rear wheel regenerative braking. The controller 140 may release an application of the additional allowance information to the vehicle control when the additional release condition is satisfied.

For example, the additional release condition may include a first release condition for determining whether a stability control function of the vehicle is in operation, a second release condition based on a wheel slip rate of the vehicle, a third release condition based on a steering angle of the vehicle, and a fourth release condition based on whether the regenerative braking of the vehicle is stopped.

The second release condition may be determined based on whether the wheel slip rate of the vehicle is greater than or equal to a wheel slip rate defined in a wheel slip release condition. Additionally, the third release condition may be determined based on whether the steering angle of the vehicle is equal to or greater than a steering angle defined in a steering angle control release condition.

The controller 140 may release the application of the additional allowance information when at least one of the first to fourth release conditions is satisfied.

The derivation unit 130 may derive a reduction rate of the additional allowance amount of the rear wheel regenerative braking when releasing the application of the additional allowance information. The reduction rate of the additional allowance amount refers to the speed at which the additional allowance regenerative amount applied to the rear wheel is reduced to zero. The derivation unit 130 may derive the reduction rate of the additional allowance amount of the rear wheel regenerative braking based on a ratio of an additional allowance amount of rear wheel regenerative braking previously applied to the reference reduction time.

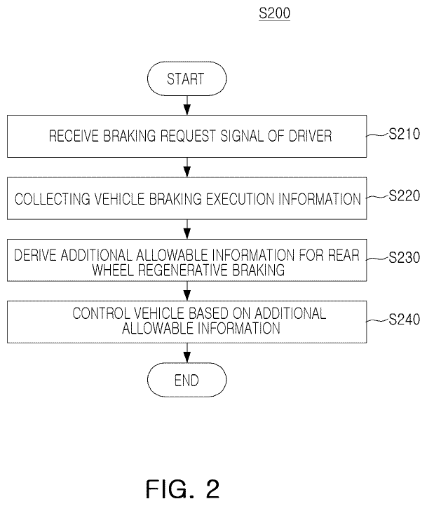

FIG. 2 is a flowchart of a vehicle control method according to an embodiment of the present disclosure. Referring to FIG. 2, a vehicle control method (S200) may include an operation of receiving a braking request signal from a driver (S210), an operation of collecting vehicle braking execution information (S220), an operation of deriving additional allowance information for rear wheel regenerative braking (S230), and an operation of controlling a vehicle based on the additional allowance information (S240).

In the operation of receiving the braking request signal of the driver (S210), the braking request signal of the driver may be input through a brake pedal sensor. The braking request signal of the driver may include a total braking torque.

In the operation of collecting vehicle braking execution information (S220), braking execution information of the vehicle may include regenerative braking execution information and hydraulic braking execution information.

In the operation of deriving additional allowance information of the rear wheel regenerative braking (S230), additional allowance information of the rear wheel regenerative braking may be derived based on the braking request signal and the braking execution information.

The operation of deriving additional allowance information of the rear wheel regenerative braking (S230) may include an operation of deriving an additional allowance amount of the rear wheel regenerative braking and an operation of deriving an increase rate of the additional allowance amount of the rear wheel regenerative braking.

In the operation of deriving the additional allowance amount of the rear wheel regenerative braking, the additional allowance amount may be derived as a smaller value among a value obtained by subtracting a torque based on the regenerative braking execution information and the minimum secured hydraulic pressure from a total braking torque included in the braking request signal, and a preset maximum additional allowance amount.

The minimum secured hydraulic pressure may have a preset value based on the hydraulic compensation speed.

In the operation of deriving the increase rate of additional allowance amount of rear wheel regenerative braking, the increase rate of additional allowance amount may be derived as a smaller value among a ratio of the additional allowance amount of the rear wheel regenerative braking to reference increase time and a preset maximum increase rate.

In the operation (S240) of controlling the vehicle based on the additional allowance information, an allowance amount of the rear wheel regenerative braking may be increased based on the additional allowance amount of the rear wheel regenerative braking and the increase rate of the additional allowance amount derived from S230.

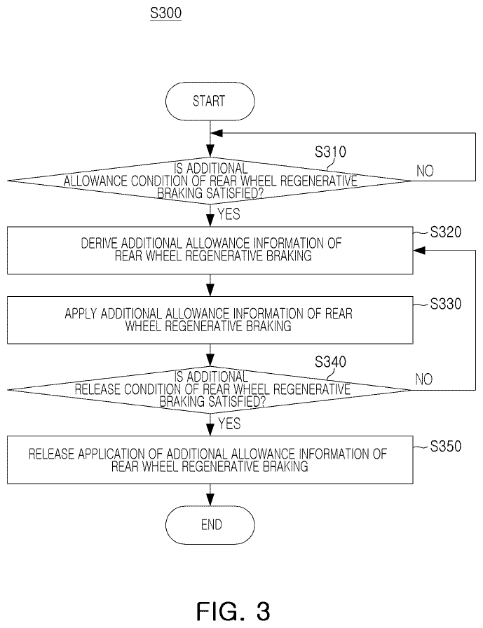

FIG. 3 is a flowchart of a vehicle control method according to an embodiment of the present disclosure. Referring to FIG. 3, a vehicle control method (S300) may include an operation (S310) of determining whether an additional allowance condition of the rear wheel regenerative braking is satisfied. The additional allowance condition of the rear wheel regenerative braking may include one or more conditions.

For example, the additional allowance condition of rear wheel regenerative braking may include a first allowance condition for determining whether the braking request signal is input, and a second allowance condition for determining whether an execution amount of the rear wheel regenerative braking is equal to a basic allowance amount of the rear wheel regenerative braking. The additional allowance condition of rear wheel regenerative braking may also include a third allowance condition for determining whether a pressure of a master cylinder of the vehicle is greater than or less than a minimum secured hydraulic pressure, and a fourth allowance condition for determining whether a stability control function of the vehicle is not operating.

When it is determined in S310 that the additional allowance condition of the rear wheel regenerative braking is satisfied, the process may proceed to an operation (S320) of deriving additional allowance information of the rear wheel regenerative braking.

The additional allowance information of the rear wheel regenerative braking may include an additional allowance amount of the rear wheel regenerative braking and an increase rate of the additional allowance amount.

When the additional allowance condition of the rear wheel regenerative braking is not satisfied in S310, the operation (S310) for determining whether the additional allowance condition of the rear wheel regenerative braking is satisfied may be performed again.

Following S320, an operation (S330) of applying additional allowance information of the rear wheel regenerative braking may be performed. In the operation (S330) for applying additional allowance information, the vehicle may be controlled to increase an allowance amount of the rear wheel regenerative braking based on the additional allowance amount of the rear wheel regenerative braking and the increase rate of the additional allowance amount of rear wheel regenerative braking.

Next, an operation (S340) of determining whether the additional release condition of the rear wheel regenerative braking is satisfied may be performed.

For example, the additional release condition may include a first release condition for determining whether the stability control function of the vehicle is in operation, a second release condition based on a wheel slip rate of the vehicle, a third release condition based on a steering angle of the vehicle, and a fourth release condition based on whether the regenerative braking of the vehicle is stopped.

The second release condition may be determined based on whether the wheel slip rate of the vehicle is equal to or greater than a wheel slip rate previously defined in the wheel slip release condition. Additionally, the third release condition may be determined based on whether the steering angle of the vehicle is equal to or greater than a steering angle previously defined in the steering angle control release condition.

When it is determined that the additional release condition of the rear wheel regenerative braking is satisfied in S340, the process may proceed to an operation (S350) of releasing an application of the additional allowance information of the rear wheel regenerative braking.

When it is determined that the additional release condition of the rear wheel regenerative braking is not satisfied in S340, the process may proceed to the operation (S320) of deriving the additional allowance information of the rear wheel regenerative braking again.

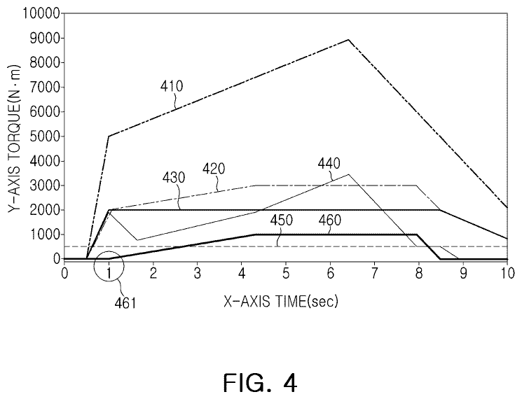

FIG. 4 is a graph illustrating a braking torque when a vehicle control method according to an embodiment of the present disclosure is performed.

In FIG. 4, 410 may represent a total braking torque included in a braking request signal of a driver, 420 may represent an execution amount of rear wheel regenerative braking, 430 may represent a basic allowance amount of the rear wheel regenerative braking, 440 may represent an execution amount of hydraulic braking, and 450 may represent a minimum secured hydraulic pressure. Additionally, 460 represents an additional allowance amount of the rear wheel regenerative braking, and illustrates a case in which the additional allowance condition of the rear wheel regenerative braking is satisfied in 461.

The present disclosure may control the vehicle based on the additional allowance information of the rear wheel regenerative braking, so that a total regenerative braking amount may be increased, thereby exerting an effect of improving the electric efficiency.

Additionally, a rear wheel regenerative braking amount may be increased, thereby exerting an effect of preventing overheating of the rear wheel brake and improving the vehicle stability.

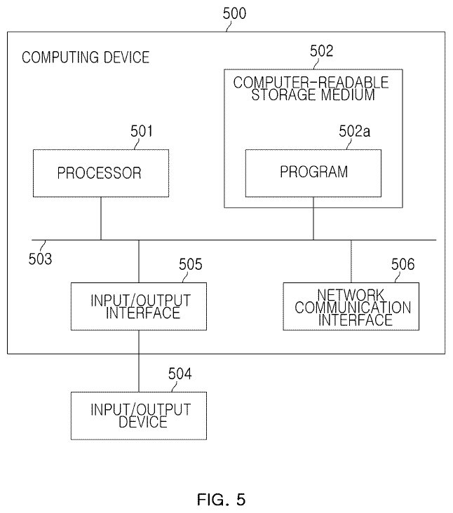

FIG. 5 is a block diagram of a computing device 500 that may fully or partially implement a vehicle system 10 according to an embodiment of the present disclosure, and may include all or a portion of the vehicle system 10 illustrated in FIG. 1.

As illustrated in FIG. 5, a computing device 500 includes at least one processor 501, a computer-readable storage medium 502, and a communication bus 503.

The processor 501 may cause the computing device 500 to operate according to the embodiment described above. For example, the processor 501 may execute one or more programs stored in the computer-readable storage medium 502. The one or more programs may include one or more computer-executable instructions, and the computer-executable instructions, when executed by the processor 501, may be configured to cause the computing device 500 to perform operations according to an embodiment.

The computer-readable storage medium 502 is configured to store computer-executable instructions or program codes, program data, and/or other suitable forms of information. A program 502a stored on the computer-readable storage medium 502 includes a set of instructions executable by the processor 501. In an embodiment, the computer-readable storage medium 502 may be a memory (a volatile memory, such as a random access memory, a nonvolatile memory, or a suitable combination thereof), one or more magnetic disk storage devices, optical disk storage devices, flash memory devices, or any other form of storage medium that is accessible by the computing device 500 and capable of storing desired information, or suitable combinations thereof.

The communication bus 503 interconnects various other components of the computing device 500, by connecting the processor 501 and the computer-readable storage medium 502.

The computing device 500 may also include one or more input/output interfaces 505 providing interfaces for one or more input/output devices 504, and one or more network communication interfaces 506. The input/output interfaces 505 and the network communication interfaces 506 are connected to the communication bus 503.

The network communication interface 506 is an interface for communication within the vehicle or for communication between the vehicle and other devices outside the vehicle, and may include, for example, a Controller Area Network (CAN), a Media Oriented Systems Transport (MOST) network, a Local Interconnect Network (LIN), and/or X-by-Wire (Flexray), Wi-Fi, Bluetooth, near field communication NFC, and radio frequency identification (RFID). The network may be a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), or any other cellular network.

The input/output device 504 may be connected to other components of the computing device 500 via the input/output interface 505. Input/output devices 504 may include input devices such as a pointing device (e.g., a mouse or trackpad), a keyboard, a touch input device (e.g., a touchpad or touchscreen), a voice or sound input device, various types of sensor devices, and/or a photographing device, and/or output devices such as a display device, a printer, a speaker, and/or a network card. The input/output device 504 may be included in the computing device 500 as a component forming the computing device 500, or may be connected to the computing device 500 as a separate device distinct from the computing device 500.

An embodiment of the present disclosure may include a program for performing the methods described in this specification on a computer, and a computer-readable recording medium including the program. The computer-readable recording medium may include program commands, local data files, local data structures, and the like, alone or in combination. The medium may be those designed and configured specifically for the present disclosure, or may be those commonly available in the computer software field. Examples of the computer-readable recording medium include magnetic media such as a hard disk, a floppy disk, and a magnetic tape, optical recording media such as a compact disc-read only memory (CD-ROM) and a digital versatile disc (DVD), and hardware devices specifically configured to store and perform program commands such as a read only memory (ROM), a random access memory (RAM), and a flash memory. The program examples may include not only machine language codes such as those generated by a compiler, but also high-level language codes that may be executed by a computer using an interpreter.

Although representative example embodiments of the present disclosure have been described in detail above, those having ordinary skill in the art should understand that the above-described embodiments can be modified in various ways without departing from the scope of the present disclosure. Therefore, the scope of the present disclosure should not be limited to the described example embodiment and should be determined by the claims described below as well as those equivalent to the claims.

What is claimed is:

1. A vehicle control method, the method performed on a computing device including a processor, and a storage medium storing instructions executable by the processor, the method comprising:
receiving a braking request signal from a driver;
collecting vehicle braking execution information performed based on the braking request signal;
deriving additional allowance information of rear wheel regenerative braking based on the braking request signal and the vehicle braking execution information; and
controlling the vehicle based on the additional allowance information of the rear wheel regenerative braking,
wherein the vehicle braking execution information includes regenerative braking execution information and hydraulic braking execution information.

2. The vehicle control method according to claim 1, further comprising:
determining an additional allowance condition of rear wheel regenerative braking based on the braking request signal and the vehicle braking execution information,
wherein in deriving additional allowance information of the rear wheel regenerative braking, the additional allowance information is derived when the additional allowance condition is satisfied.

3. The vehicle control method according to claim 2, wherein the additional allowance condition of the rear wheel regenerative braking comprises:
a first allowance condition for determining whether a braking request signal is input;
a second allowance condition for determining whether an execution amount of the rear wheel regenerative braking is equal to a basic allowance amount of the rear wheel regenerative braking;
a third allowance condition for determining whether master cylinder pressure of the vehicle is greater than or less than minimum secured hydraulic pressure; and
a fourth allowance condition for determining whether a stability control function of the vehicle is not operating.

4. The vehicle control method according to claim 1, wherein deriving additional allowance information of the rear wheel regenerative braking comprises:
deriving an additional allowance amount of the rear wheel regenerative braking; and
deriving an increase rate of the additional allowance amount of the rear wheel regenerative braking.

5. The vehicle control method according to claim 4, wherein in the deriving the additional allowance amount of the rear wheel regenerative braking, the additional allowance amount is derived as a smaller value among a value obtained by subtracting a torque based on the regenerative braking execution information and minimum secured hydraulic pressure from a total braking torque included in the braking request signal, and a preset maximum additional allowance amount, and
wherein the minimum secured hydraulic pressure has a preset value based on hydraulic pressure compensation speed.

6. The vehicle control method according to claim 4, wherein in the deriving an increase rate of the additional allowance amount of the rear wheel regenerative braking, the increase rate of the additional allowance amount is derived as a smaller value among a ratio of an additional allowance amount of the rear wheel regenerative braking to reference increase time and a preset maximum increase rate.

7. The vehicle control method according to claim 1, wherein the controlling the vehicle comprises:
determining an additional release condition of the rear wheel regenerative braking; and
releasing an application of the additional allowance information when the additional release condition is satisfied.

8. The vehicle control method according to claim 7, wherein the additional release condition comprises:
a first release condition for determining whether a stability control function of the vehicle is in operation;
a second release condition based on a wheel slip rate of the vehicle;
a third release condition based on a steering angle of the vehicle; and
a fourth release condition based on whether regenerative braking of the vehicle is stopped.

9. The vehicle control method according to claim 7, wherein the releasing an application of the additional allowance information comprises:
deriving a reduction rate of an additional allowance amount of the rear wheel regenerative braking.

10. A vehicle control apparatus, comprising:
a processor; and
a storage medium storing instructions executable by the processor that, when executed by the processor, cause the processor to:
receive a braking request signal from a driver,
collect braking execution information of a vehicle, performed based on the braking request signal,
derive additional allowance information of rear wheel regenerative braking based on the braking request signal and the braking execution information of the vehicle, and
control the vehicle based on the additional allowance information of the rear wheel regenerative braking,
wherein the braking execution information of the vehicle includes regenerative braking execution information and hydraulic braking execution information.

11. The vehicle control apparatus according to claim 10, wherein the processor is further configured to:
determine an additional allowance condition of the rear wheel regenerative braking based on the braking request signal and the braking execution information of the vehicle; and
derive the additional allowance information when the additional allowance condition is satisfied.

12. The vehicle control apparatus according to claim 11, wherein the additional allowance condition of the rear wheel regenerative braking comprises:
a first allowance condition for determining whether a braking request signal is input;
a second allowance condition for determining whether an execution amount of the rear wheel regenerative braking is equal to a basic allowance amount of the rear wheel regenerative braking;
a third allowance condition for determining whether master cylinder pressure of the vehicle is greater than or less than minimum secured hydraulic pressure; and
a fourth allowance condition for determining whether a stability control function of the vehicle is not operating.

13. The vehicle control apparatus according to claim 10, wherein the processor is further configured to:
derive an additional allowance amount of the rear wheel regenerative braking; and
derive an increase rate of the additional allowable amount of the rear wheel regenerative braking.

14. The vehicle control apparatus according to claim 13, wherein the processor is further configured to:
derive the additional allowance amount as a smaller value among a value obtained by subtracting a torque based on the regenerative braking execution information and minimum secured hydraulic pressure from a total braking torque included in the braking request signal, and a preset maximum additional allowance amount, and
wherein the minimum secured hydraulic pressure has a preset value based on hydraulic pressure compensation speed.

15. The vehicle control apparatus according to claim 13, wherein the processor is further configured to:
derive the additional allowance increase rate as a smaller value among a ratio of an additional allowance amount of the rear wheel regenerative braking to reference increase time and a preset maximum increase rate.

16. The vehicle control apparatus according to claim 10, wherein the processor is further configured to:
determine an additional release condition of the rear wheel regenerative braking; and
release an application of the additional allowance information when the additional release condition is satisfied.

17. The vehicle control apparatus according to claim 16, wherein the additional release condition comprises:
a first release condition for determining whether a stability control function of the vehicle is in operation;
a second release condition based on a wheel slip rate of the vehicle;
a third release condition based on a steering angle of the vehicle; and
a fourth release condition based on whether regenerative braking of the vehicle is stopped.

18. The vehicle control apparatus according to claim 16, wherein the processor is further configured to:
derive a reduction rate of an additional allowance amount of the rear wheel regenerative braking.

19. A vehicle system, comprising:
a battery;
a driving mechanism including a front wheel and a rear wheel; and
a processor configured to:
receive a braking request signal of a driver,
collect braking execution information of a vehicle performed based on the braking request signal,
derive additional allowance information of the rear wheel regenerative braking based on the braking request signal and the braking execution information of the vehicle, and
control the vehicle based on the additional allowance information of the rear wheel regenerative braking,
wherein the braking execution information of the vehicle includes regenerative braking execution information and hydraulic braking execution information.

20. The vehicle system according to claim 19, wherein the processor is further configured to:
derive an additional allowance amount of the rear wheel regenerative braking; and
derive an increase rate of the additional allowance amount of the rear wheel regenerative braking.
